(19) United States
(12) Patent Application Publication
(10) Pub. No.: US 2008/0211239 A1
(43) Pub. Date: Sep. 4, 2008

(54) SECURITY IMPROVEMENT TO SOLENOID-RELEASABLE MORTISE LOCKSET HAVING THUMB-LEVER ACTUATORS

(76) Inventor: Jon Edward Keller, Pleasant Grove, UT (US)

Correspondence Address: Angus C. Fox, III, 4093 N. Imperial Way, Provo, UT, 84604-5386, US

(21) Appl. No.: 12/040,918

(22) Filed: Mar. 3, 2008

Related U.S. Application Data
(60) Provisional application No. 60/892,768, filed on Mar. 2, 2007.

(51) Int. Cl. E05C 1/12; E05C 1/08

(52) U.S. Cl. 292/164; 292/137

(57) ABSTRACT

An improved version of a solenoid-releasable Baldwin® mortise lockset having thumb-lever actuators is provided. Components from a thumb-lever-actuated mortise lockset are combined with those of a knob-actuated mortise lock from the same manufacturer. The sheet metal of the rocking bolt-locking plate of the knob-actuated lockset and of the exterior thumb-lever actuator bracket from the other lockset are thinned in certain regions. In addition, a new vertical-to-horizontal motion converter arm has been designed and installed in the improved lockset. A rounded upper portion of the new converter arm operates on a bottom edge of the bolt-locking plate, causing it to pivot and release the latch bolt. The new converter arm retracts the latch bolt by operating on a projection on the front side, rather than on the back side thereof.₍₁₄₀₎

This application has a claim of priority based on the filing of provisional patent application No. 60/892,768 titled SECURITY IMPROVEMENT TO SOLENOID-ACTUATED BALDWIN MORTISE LOCK HAVING THUMB-LEVER ACTUATORS, by the same inventor, on Mar. 2, 2007.

### BACKGROUND OF THE INVENTION

1. Field of the Invention

This invention relates, generally, to door locks and, more particularly, to an improvement to a solenoid-actuated, Baldwin® mortise lockset, which prevents the latch bolt from being retracted using a laminar lock-picking tool, such as a credit card.

2. Description of the Prior Art

A mortise lockset is one that requires a mortise, or pocket, to be cut into the edge of a door into which the lockset is to be installed. Mortise locksets were invented in the early 1900's and, in most parts of the world, are generally found on the doors of older buildings constructed before the advent of bored cylindrical locksets. Despite the fact that a timber door is weakened somewhat by the mortise, mortise locksets offer certain advantages over bored cylindrical locksets, which as led to their recent resurgence in commercial and upscale residential construction in the United States. Mortise locksets typically have heavier, longer-wearing parts, integrated locking, and increased security. For example, Baldwin® mortise locksets typically have two hardened pins in the deadbolt rather than one, it is much more difficult to cut through it. They also incorporate an anti-friction latch bolt, which requires less effort when latching the door shut. In addition, as a mortise lockset provides full integration of the latch bolt and deadbolt rather than the two acting as individual components, both the deadbolt and latch bolt can be retracted by inserting the key in only one cylinder, rather than in two. The latch bolt and deadbolt integration also permits easy egress in case of an emergency.

The Baldwin Lock Company supplies two basic types of mortise locksets. The first is a thumb-lever model which incorporates a deadbolt. The Baldwin® model 6024 mortise lockset is exemplary of this first type. The second is a knob-actuated model which incorporates a security striker bar in place of the deadbolt. The Baldwin® model 6053 mortise lockset is exemplary of this second type. Many Baldwin® mortise locksets of both types are being modified, by companies other than The Baldwin Lock Company, to incorporate a solenoid-releasable lock for the outside actuator, whether it be a knob or thumb-lever. Such modified locksets have become particularly popular for both certain commercial buildings and for secure multi-unit residential complexes. For example, an apartment building might use such a lockset so that an apartment resident may provide access to visitors who have announced their arrival over an intercom system by merely pressing a button in the apartment that remotely activates the solenoid-releasable lock. The knob-actuator types offer the most secure conversions, as the security striker bar is unaffected by the conversion. However, the security of the thumb-lever-actuator types is compromised, as it is necessary to remove the deadbolt so that the solenoid-releasable lock may be the sole locking device. As there is no security striker bar on the Baldwin® thumb-lever type mortise locksets, it is possible to defeat a converted thumb-lever model by causing the latch bolt of the mortise lockset to retract by applying a lateral force on the tapered exposed end thereof with a thin, laminar picking tool, such as a credit card. This is done by simply sliding the card into the crack between the door and the door jam at the latching striker location. As commercial doors almost invariably open outward with respect to the building, the crack is typically unshielded.

What is needed is an improved version of a solenoid-releasable lock conversion of a Baldwin® mortise lockset having thumb-lever interior and exterior actuators.

### SUMMARY OF THE INVENTION

The present invention provides enhanced security for a Baldwin® mortise lockset with thumb-lever interior and exterior actuators that has received a solenoid-releasable latch bolt conversion. The improvement includes starting with the housing of a knob-actuated mortise lockset, such as the model 6053, replacing the knob actuator components with the interior and exterior thumb-lever lift brackets from the 6024 model, milling certain regions of the steel sheet metal rocking bolt-locking plate from the 6053 model to a depth of about 0.010 inches (approximately 0.25 mm) so that its thickness is reduced from about 0.120 inches (approximately 3.0 mm) to about 0.10 inches (approximately 2.54 mm) in those regions. In addition, rather than using the vertical-to-horizontal motion converter arm of the 6024 model mortise lockset, which operates on a protuberance on the back side of the latch bolt shank 104B, a new motion converter arm is designed and installed in the 6053 lockset that operates on a protuberance on the front side of the latch bolt shank 104B. A rounded upper portion of the new converter arm operates on a bottom edge of the bolt-locking plate, thereby causing the latter to pivot in a counterclockwise direction (i.e., toward the rear of the lockset housing) so that it releases the latch bolt. A coil spring appropriated from the thumb-lever-actuated lockset is employed to return the new vertical-to-horizontal motion converter arm to its original position. Proper positioning of one end of the coil spring on the motion converter arm is maintained by a projection on the latter, while proper positioning of the opposite end on the rear of the case is maintained by a cylindrical projection that is preferably swaged to the rear of the case. The improved version of the solenoid-releasable lock conversion of the Baldwin® mortise lockset can be operated in three modes: using a key to rotate the tumbler lock which is installed in the lockset; using an inside thumb lever; and using an outside thumb lever after the outside thumb lever lift bracket is unlocked by application of electric current to the solenoid.

### BRIEF DESCRIPTION OF THE DRAWINGS

FIG. 1 is an elevational view of a Baldwin mortise lockset housing, with the front main plate secured thereto, and with the tumbler-actuated latch bolt release lever assembly, anti-friction latch bolt and latch bolt coil biasing spring assembly installed therein;

FIG. 2 is an elevational view of the partially-assembled Baldwin mortise lockset of FIG. 1, but with the rotational lock for the screw-in tumbler lock (not shown) installed therein;

FIG. 3 is an elevational view of the partially-assembled Baldwin mortise lockset of FIG. 2, but with the bolt-locking plate release lever and its associated torsion biasing spring, a front thumb-lever lift bracket configured for interior access, and a security striker bar and associated coil biasing spring installed therein;

FIG. 4 is an elevational view of the partially-assembled Baldwin mortise lockset of FIG. 3, but with the rocking bolt-locking plate, associated torsion biasing spring, and vertical-to-horizontal motion converter arm installed therein;

FIG. 5 is an elevational view of the partially-assembled Baldwin mortise lockset of FIG. 4, but with a rear thumb-lever lift bracket configured for exterior access, and a solenoid-actuated lock installed therein, the solenoid-actuated lock blocking actuation of the thumb-lever lift bracket that is configured for exterior access;

FIG. 6 is an elevational view of the lockset cover plate;

FIG. 7 is an elevational view of the fully-assembled (minus the lock tumbler) Baldwin mortise lockset of FIG. 4, but with the lockset cover plate installed thereon and the front trim plate of FIG. 21 secured to the front main plate;

FIG. 8 is an elevational view of the Baldwin mortise lockset assembly of FIG. 5, with the security striker bar retracted into a door-closed configuration;

FIG. 9 is an elevational view of the Baldwin mortise lockset assembly of FIG. 8, with the rocking bolt-locking plate moved to an unlocked configuration by the rocking bolt-locking plate release lever, and the anti-friction latch bolt retracted by tumbler-actuated latch bolt release lever assembly;

FIG. 10 is an elevational view of the Baldwin mortise lockset assembly of FIG. 8, with the rocking bolt-locking plate moved to an unlocked configuration and the anti-friction latch bolt retracted by the vertical-to-horizontal motion converter arm, which has been rotated by upward movement of the interior thumb-lever lift bracket;

FIG. 11 is an elevational view of the Baldwin mortise lockset assembly of FIG. 8, with the rocking bolt-locking plate moved to an unlocked configuration and the anti-friction latch bolt retracted by the rocking bolt-locking plate 401, which has been rotated by upward movement of the exterior thumb-lever lift bracket following magnetic retraction of the solenoid-actuated lock;

FIG. 12 is an elevational view of the partially-assembled Baldwin mortise lockset of FIG. 2, but with the bolt-locking plate release lever and its associated torsion biasing spring, a front thumb-lever lift bracket configured for exterior access, and a security striker bar and associated coil biasing spring installed therein;

FIG. 13 is an elevational view of the partially-assembled Baldwin mortise lockset of FIG. 4, but with a rear thumb-lever lift bracket configured for interior access, and a solenoid-actuated lock installed therein, and the front trim plate of FIG. 21 secured to the front main plate, the solenoid-actuated lock blocking actuation of the thumb-lever lift bracket that is configured for exterior access;

FIG. 14 is a plan view of the rocking bolt-locking plate, showing a hatched region which has been milled, machined, ground, or stamped to reduce its thickness;

FIG. 15 is a plan view of the vertical-to-horizontal motion converter arm;

FIG. 16 is a side elevational view of the vertical-to-horizontal motion converter arm showing the offset thereon;

FIG. 17 is an elevational view of the opposite side of the rear thumb-lever lift bracket shown in FIG. 5, showing a hatched region which has been milled, machined, ground, or stamped to reduce its thickness;

FIG. 18 is an elevational view of the opposite side of the rear thumb-lever lift bracket shown in FIG. 13, showing a hatched region which has been milled, machined, ground, or stamped to reduce its thickness;

FIG. 19 is an elevational view of the complete rear thumb-lever lift bracket that is configured for interior access, as partially shown in FIG. 3;

FIG. 20 is an elevational view of the complete rear thumb-lever lift bracket that is configured for exterior access, as partially shown in FIG. 12;

FIG. 21 is an elevational view of the front trim plate; and

FIG. 22 is an elevational view of the front main plate.

### DETAILED DESCRIPTION OF THE INVENTION

The improved solenoid-releasable lock conversion of the Baldwin® mortise lockset will now be described with reference to the attached drawing figures. It should be understood that the drawings may not be exactly drawn to scale, though it was the intention to do so, and that they should be considered merely illustrative.

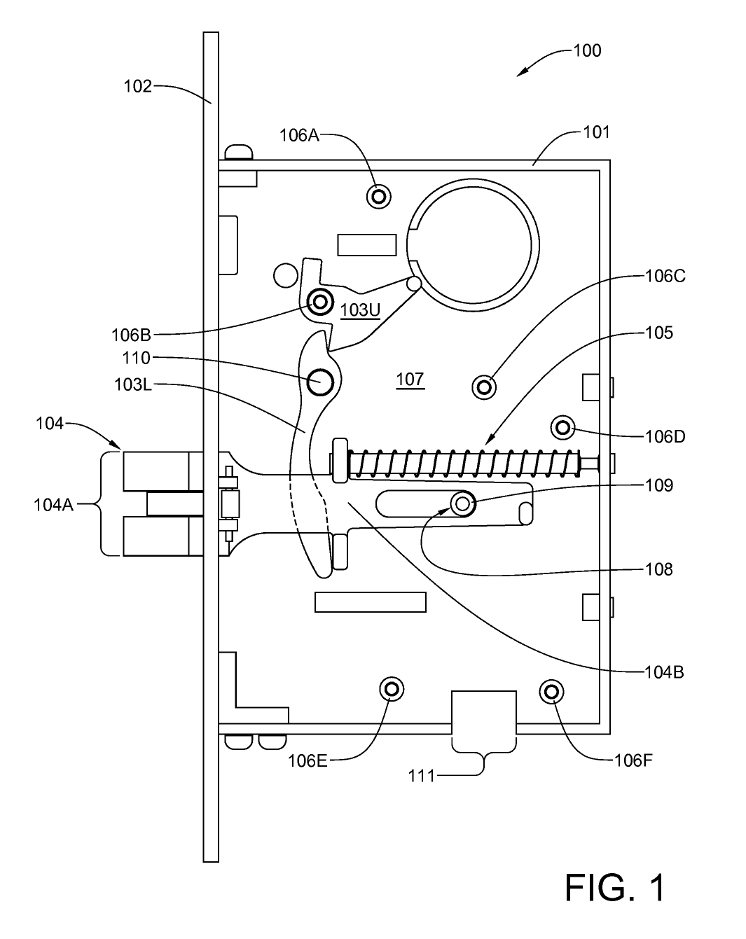

Referring now to FIG. 1, an incomplete mortise lockset assembly 100 is shown which includes a Baldwin mortise housing 101, a front main plate 102 secured to the housing 101, a tumbler-actuated latch bolt release lever assembly comprised of an upper lever arm 103U and a lower lever arm 103L, a latch bolt 104 having an anti-friction, latching striker 104A and a shank portion 104B, and latch bolt coil biasing spring assembly 105. Six internally-threaded stand-off pins 106A, 106B, 106C, 106D, 106E and 106F are swaged and rigidly affixed to the rear panel 107. Guide/pivot pin 108 has a cylindrical projection 109, the function of which will be subsequently appreciated. It will be noted that the lower lever arm 103L pivots on a lower lever arm pivot pin 110. In addition, although the housing 109 is from a model 6053 knob-actuated mortise lockset, it is virtually identical to the housing used for the thumb-lever-actuated Baldwin model 6024 mortise lockset. It even has the cutout 111 at the bottom of the housing 101 which is used to couple the thumb-lever actuators (not shown) and the internal lift components in the thumb-lever-actuated models, such as the Baldwin model 6024 mortise lockset.

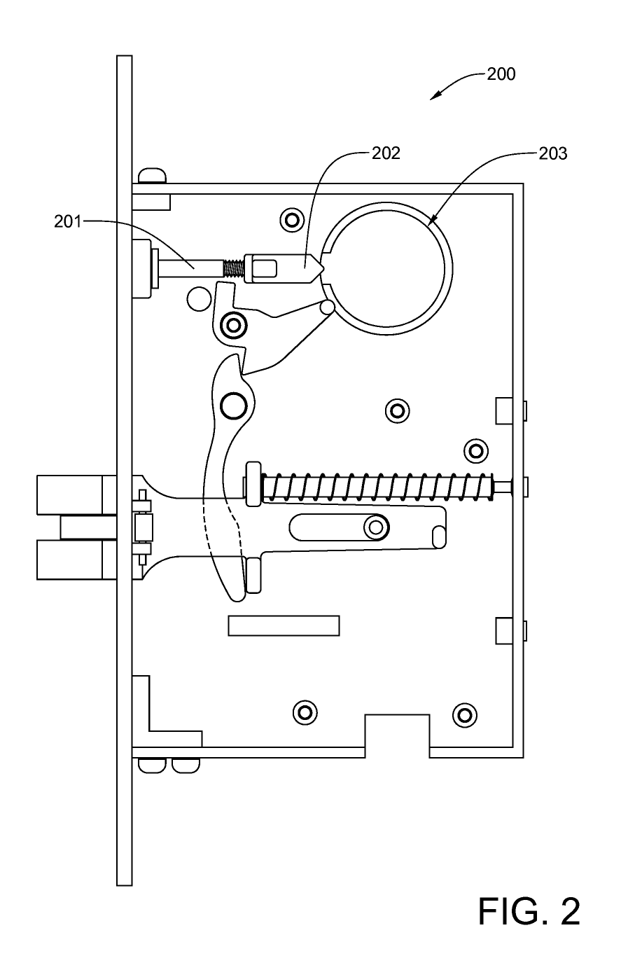

Referring now to FIG. 2, a rotational lock 201 consisting of a left-hand-threaded screw 202 and a pointed locking head 203, has been added to the assembly 100 of FIG. 1, resulting in a still incomplete lockset assembly 200. A rotating tumbler lock (not shown) is screwed into the threaded aperture 204 and locked in place by the rotational lock 201.

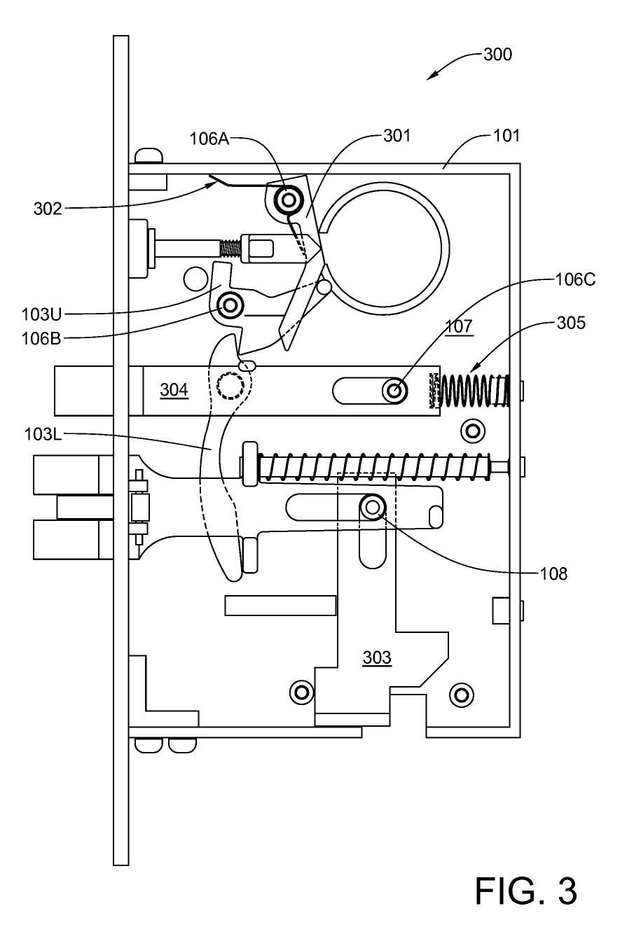

Referring now to FIG. 3, a bolt-locking plate release lever 301, a first torsion biasing spring 302 associated with the bolt-locking plate release lever 301, a front thumb-lever lift bracket configured for interior access 303, a security striker bar 304, and a security striker bar coil biasing spring 305 have been installed in the assembly 200 of FIG. 2, resulting in the still incomplete lockset assembly 300.

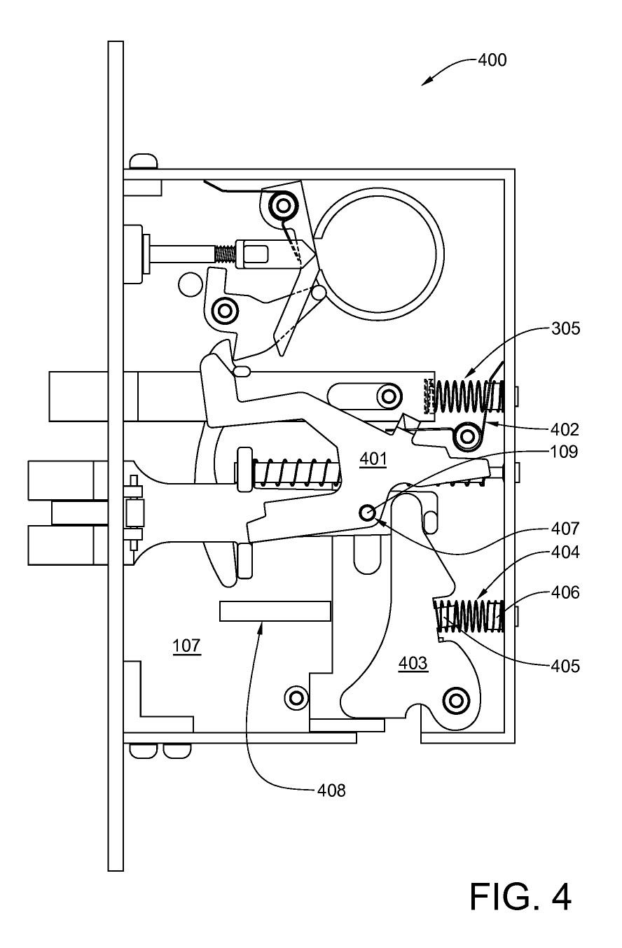

Referring now to FIG. 4, a rocking bolt-locking plate 401, a second torsion biasing spring 402 associated with the rocking bolt-locking plate 401, a vertical-to-horizontal motion converter arm 403, and a motion converter arm coil biasing spring 404 have been installed in the assembly 300 of FIG. 3, resulting in the still incomplete lockset assembly 400. The motion converter arm coil biasing spring 404 is obtained from the thumb-lever-actuator lockset. One end of the motion converter arm coil biasing spring 404 fits over a projection 405 on the motion converter arm 403 while the opposite end thereof fits over a cylindrical projection 406 that is swaged to the rear of the housing 101. It will be noted that a circular aperture 407 in the rocking bolt-locking plate 401 fits over the cylindrical projection 109 of guide/pivot pin 108. There is sufficient clearance so that the rocking bolt-locking plate 401 can pivot with a rocking motion about the cylindrical projection 109 with minimal friction. It will be noted that there is a horizontally-oriented locking tab guide slot 408, the function of which will be subsequently described.

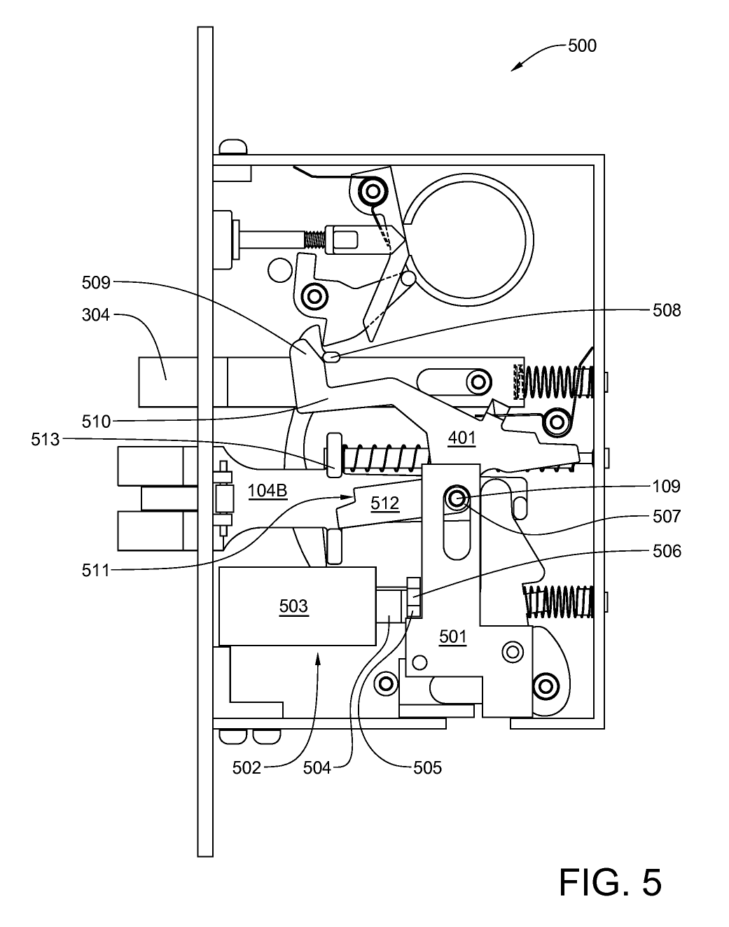

Referring now to FIG. 5, a rear thumb-lever lift bracket configured for exterior access 501 and a solenoid-actuated lock 502 for the rear thumb-lever lift bracket 501 have been installed in the assembly 400 of FIG. 4, resulting in the still incomplete lockset assembly 500. It will be noted that the solenoid-actuated lock 502 comprises a solenoid 503 having a hollow core, a rod 504 slidable within the hollow core, and a locking tab 505 rigidly affixed to the end of the rod 504. It will be noted that the locking tab 505 has a upper projection 506 that rides within a overlying slot in the front cover plate. It also has an identical lower projection (not shown) that rides within the underlying locking tab guide slot 406 in the rear panel 107 of the housing 101. It will also be noted that a bushing 507 has been placed over the cylindrical projection 109 on guide/pivot pin 108. It will be further noted that when the security striker bar 304 is in an extended position (as shown), contact between a protuberance 508 on the security striker bar 304 and the beveled projection 509 at the free end of the top arm 510 of the rocking bolt-locking plate 401 maintains the latter so that the cutout 511 at the free end of the bottom arm 512 is outside the sliding path of a top tab 513 that is unitary with the latch bolt shank 104B.

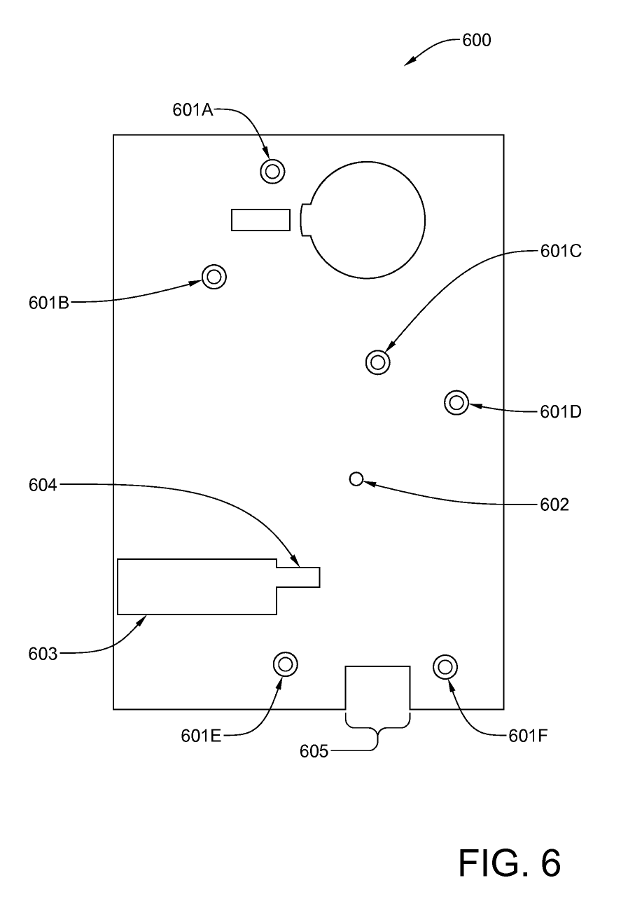

Referring now to FIG. 6, a housing cover plate 600 is shown. There are six countersunk holes 601A, 601B, 601C, 601D, 601E and 601F which receive screws having countersunk heads and which secure the cover plate 600 to the housing 101. There is also a circular aperture 602 that will receive cylindrical projection 109. A large rectangular cutout 603 in the cover plate 600 locates the solenoid 503 within the housing 101 and a small rectangular cutout 604 contiguous with the large rectangular cutout 603 locates the upper projection 506 of the locking tab 505. A cutout 506 aligns with cutout 111 in the housing 101.

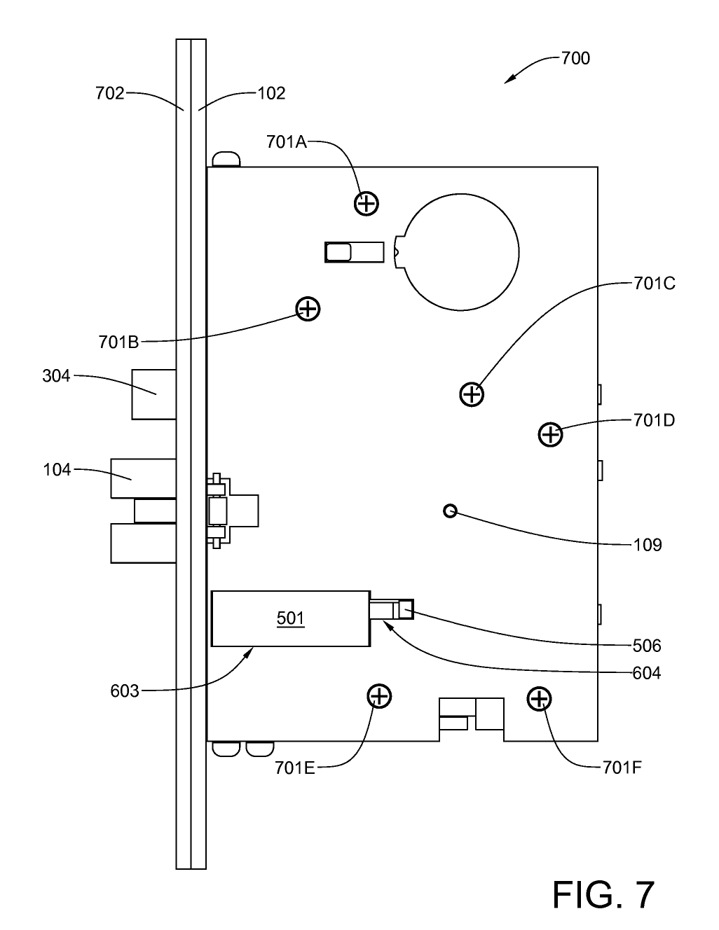

Referring now to FIG. 7, the housing cover plate 600 of FIG. 6 has been installed on the assembly of FIG. 5, and six machine screws 701A, 701B, 701C, 701D, 701E and 701F having countersunk heads are used to secure the cover plate 600 to the six internally-threaded stand-off pins 106A, 106B, 106C, 106D, 106E and 106F, respectively. The resulting assembly is a complete improved thumb-lever-actuated lockset 700. The circular aperture 602 has fit over the cylindrical projection 109 of guide/pivot pin 108. It will also be noted that the solenoid-actuated lock assembly 501 fits within the large rectangular cutout 603 in the cover plate 600, and that the upper projection 506 is slidable within the small rectangular cutout 604. It will be further noted that a front trim plate 702 has been secured to the front main plate 102.

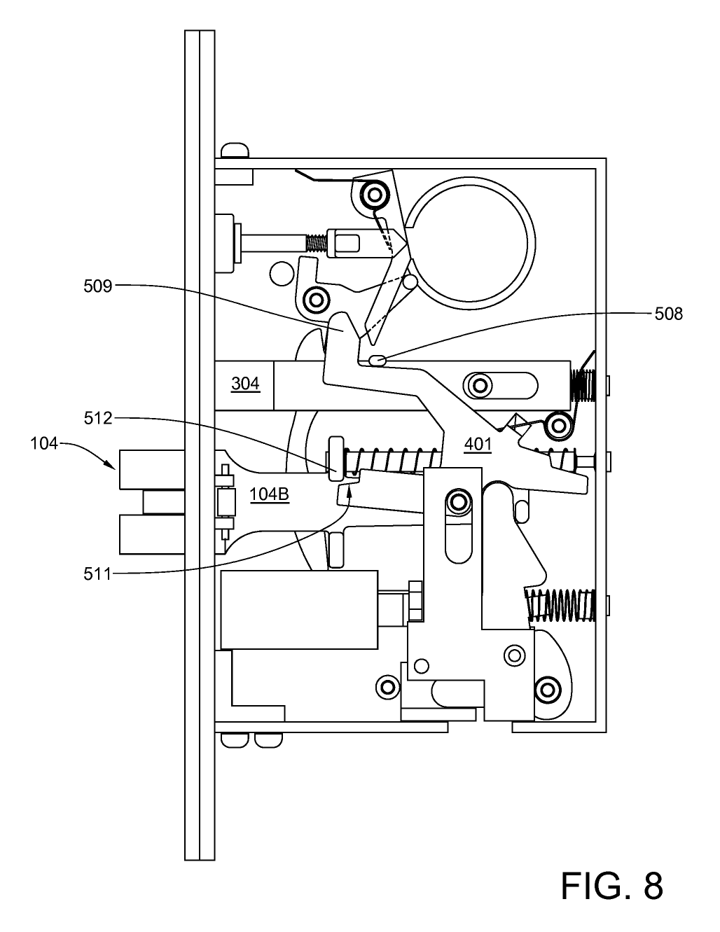

Referring now to FIG. 8, the security striker bar 304 has been retracted by, for example, closure of the door in which the improved mortise lockset 700 is installed. Retraction of the security striker bar 304 causes the protuberance 508 on the security striker bar 304 to be moved rearward to a position where it no longer contacts the beveled projection 509, thereby causing the spring-biased rocking bolt-locking plate 401 to pivot about the cylindrical projection 109 in a clockwise direction so that the cutout 511 is moved upwardly so that it will capture the top tab 512 of the latch bolt shank 104B. In other words, absent some additional intervention, the rocking bolt-locking plate 401 will prevent the retraction of the anti-friction latch bolt 104.

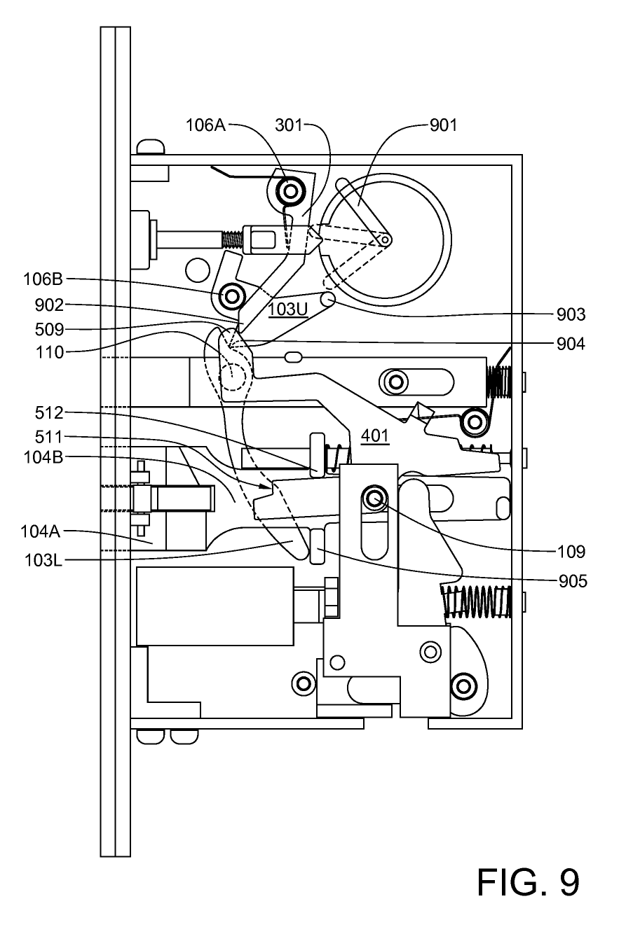

Referring now to FIG. 9, this drawing figure shows how the latch bolt can be retracted from outside the building by using a key in the tumbler to rotate an unlocking arm 901 that is integral with the tumbler (not shown). As the unlocking arm 901 is rotated in a counterclockwise direction with the key (also not shown), it first pushes against the bolt-locking plate release lever 301 so that the latter rotates clockwise about stand-off pin 106A. The lower extension 902 of the bolt-locking plate release lever 301 pushes against the beveled projection 509 of the rocking bolt-locking plate 401, causing the latter to rotate counterclockwise about the cylindrical projection 109, and causing the cutout 511 to be moved downwardly so that it will not capture the top tab 512 of the latch bolt shank 104B as the latter slides to the right. The locking arm 901 simultaneously begins to push on the top of the cylindrical projection 903 the upper lever arm 103U, causing the latter to rotate clockwise about stand-off pin 106B so that the tapered actuator 904 pushes on an upward portion of the lower lever arm 103L, causing it to rotate counterclockwise about the lower lever arm pivot pin 110, thereby forcing a bottom portion of the lower lever arm 103L against a bottom tab 905 of the latch bolt shank 104B and causing the latter component to slide to the right until the latching striker end 104A of latch bolt 104 is fully retracted. It should be obvious that once the top tab 512 has passed the cutout 511, it is no longer important that the bolt-locking plate release lever 301 continue to push against the beveled projection 509 of the rocking bolt-locking plate 401.

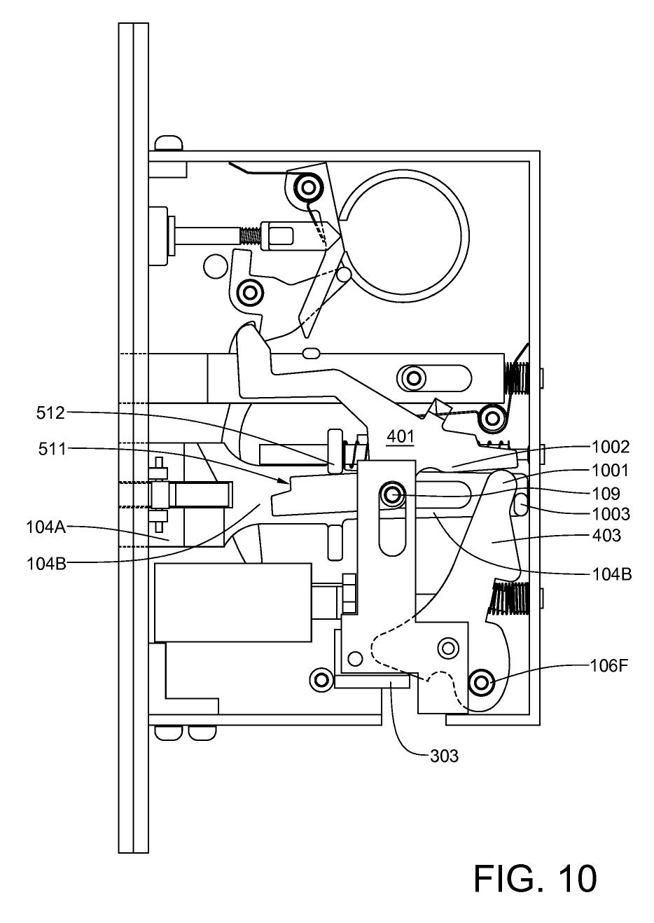

Referring now to FIG. 10, this drawing figure shows how the latch bolt can be retracted from inside the building by using only an interior thumb lever (not shown), which lifts the front thumb-lever lift bracket 303. When the front thumb-lever lift bracket 303 is moved upwardly, it causes the rounded upper end 1001 of the vertical-to-horizontal motion converter arm 403 to push on the right lower edge 1002 of the rocking bolt-locking plate 401, causing the latter to rotate counterclockwise about cylindrical extension 109 of guide/pivot pin 108, thereby moving the cutout 511 below the horizontal path of the top tab 512. At the same time, the vertical-to-horizontal motion converter arm 403 rotates clockwise about stand-off pin 106F, causing it to push against a rear projection 1003 on the latch bolt shank 104B, causing it to slide to the right and fully retract the latch bolt 104.

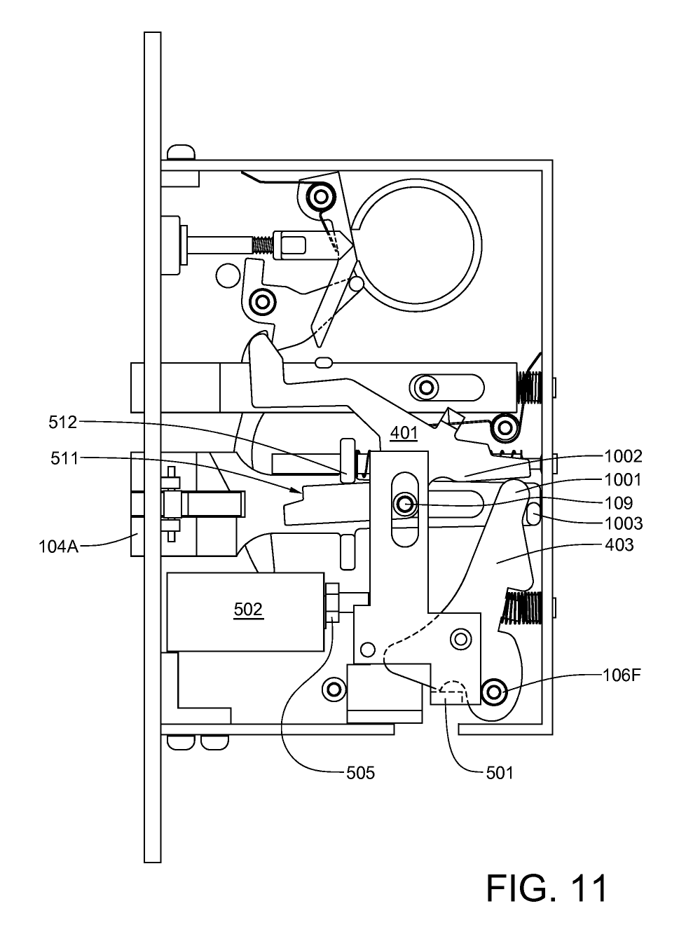

Referring now to FIG. 11, this drawing figure shows how the latch bolt can be retracted from outside the building using an exterior thumb lever (not shown), which can lift the exterior thumb-lever lift bracket 501 only after current is applied to the solenoid 503 so that the locking tab 505 is pulled to the left and out of the vertical path of the rear thumb-lever lift bracket 501. Upward movement of the rear thumb-lever lift bracket 501 has the same mechanical effect as the upward movement of the front thumb-lever lift bracket 303 in FIG. 10.

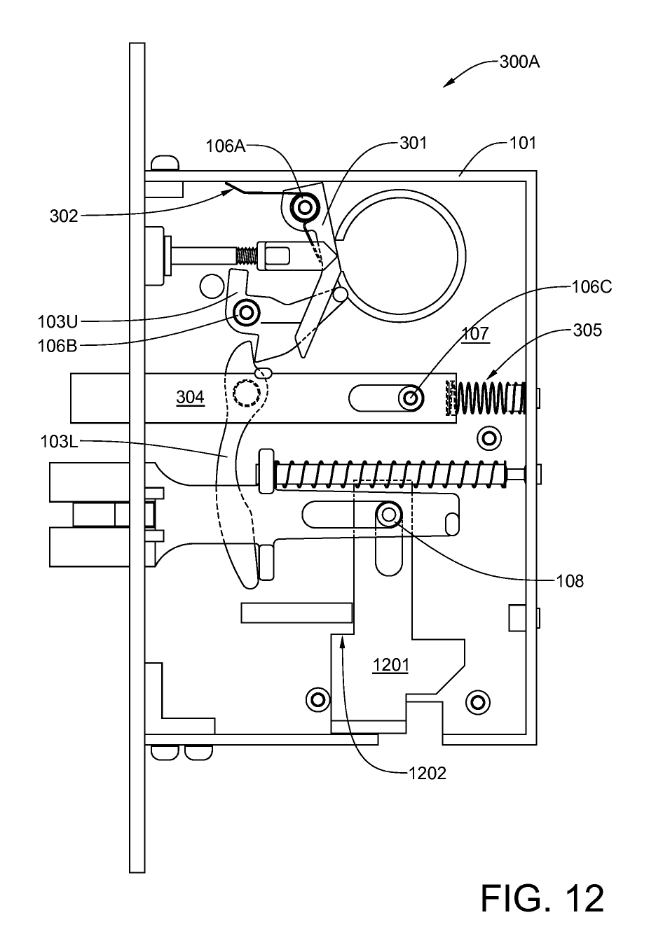

It should be understood that the improved solenoid-releasable mortise lockset 700 is reversible, in that interior/exterior access can be reversed. The thumb actuators (not shown), which are incorporated in the hardware that is secured to the outer surfaces of the door, are designed to pivot about a horizontal axis and are positioned so that they are centered with respect to the cutout 111 at the bottom of the housing 101. The actuators for both sides of the door can be identical, as they are both equipped with a lift tab that is to the left of a plane which passes through their centers perpendicular to their horizontal pivot axes. In other words, referring to FIG. 5, the thumb-actuator, which would be positioned in the foreground above the drawing surface would actuate thumb-lever lift bracket 303, which is configured as the interior lift bracket. Likewise, the thumb-actuator, which would be positioned in the background below the drawing surface (i.e., on the other side of the lockset), would actuate thumb-lever lift bracket 501, which is configured as the exterior lift bracket. Thus, there are two methods to reverse interior and exterior access. The first is to manufacture thumb actuators which are equipped with a lift tab that is to the right of the plane which passes through their centers perpendicular to their horizontal pivot axes. Although this method would certainly work, it is the more expensive of the two, as the thumb actuators must be fine finished cosmetically with precision casting, polishing, plating, and so forth. The less expensive method for reversing interior and exterior access is to simply provide a pair of front thumb-lever lift brackets and a pair of rear thumb-lever lift brackets, with members of each pair being alternately configured for either interior or exterior access. This is the less expensive method because the thumb-lever lift brackets can be stamped metal items, which require no finish work prior to plating. If configured for interior access, movement of that thumb-lever lift bracket is never blocked by the solenoid lock 502. On the other hand, if configured for exterior access, movement of that thumb-lever lift bracket is normally blocked by the solenoid lock 502. Movement of the thumb-lever lift bracket is possible only when the solenoid 503 of the lock 502 is activated. Front thumb-lever lift brackets 303 and 1201 are respectively configured for interior and exterior access, while rear thumb-lever lift brackets 501 and 1301 are respectively configured for exterior and interior access. FIGS. 12 and 13 show the improved lockset 700 configured for a reversal of access.

Referring now to the incomplete lockset 300A of FIG. 12, which corresponds to the earlier-described incomplete lockset 300 of FIG. 3, the front thumb-lever lift bracket 303, which was configured for interior access, has been replaced with a modified front thumb-lever lift bracket 1201, which is configured for exterior access.

Referring now to the alternative embodiment lockset 500A of FIG. 13, which corresponds to the earlier-described lockset 500 of FIG. 5, but with the front trim plate 702 secured to the front main plate 102, the rear thumb-lever lift bracket 501, which was configured for exterior access, has been replaced with a modified rear thumb-lever lift bracket 1301, which is configured for interior access.

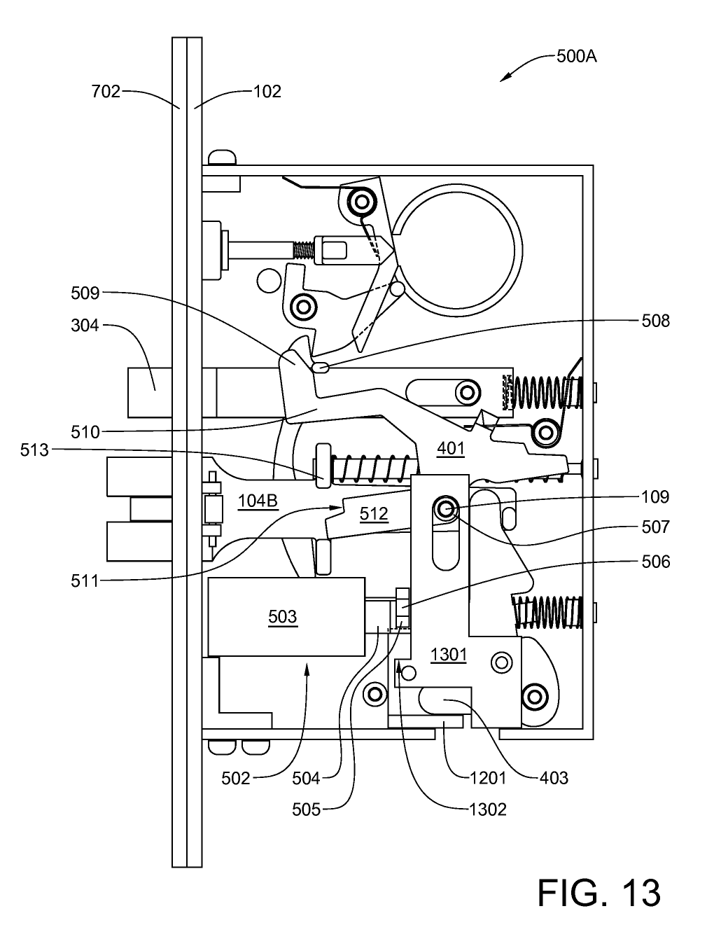

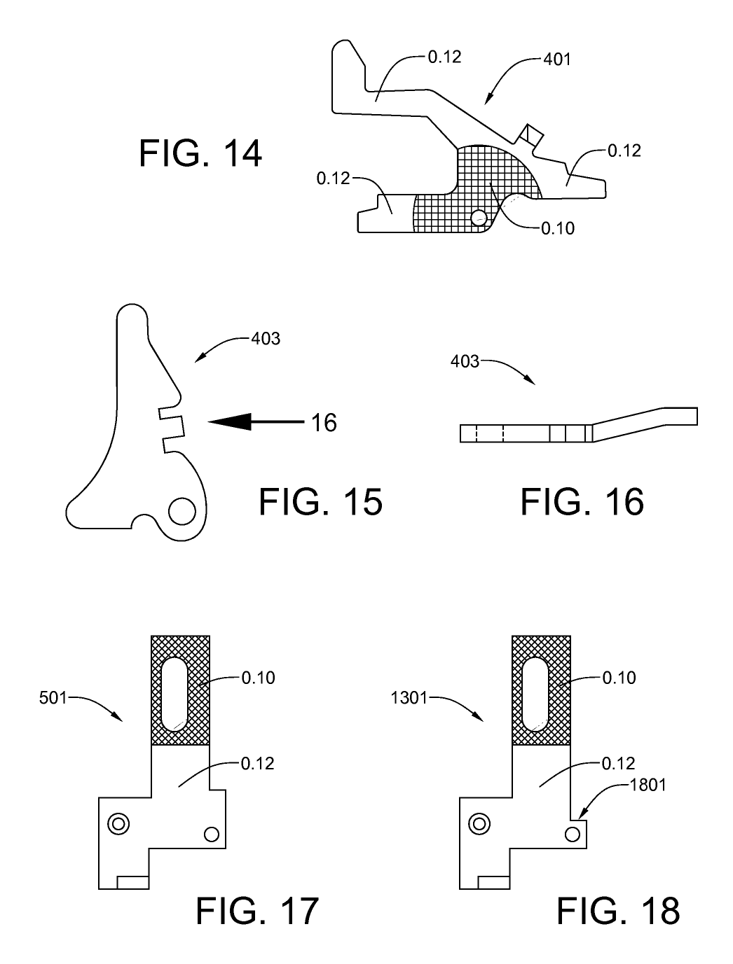

Referring now to FIG. 14, this view of the rocking bolt-locking plate 401 shows a hatched region which has been milled, machined, ground, or stamped to reduce sheet metal thickness from about 0.12 inches (approximately 3.05 mm) to about 0.10 inches (approximately 2.54 inches), in order to provide sufficient clearance within the mortise housing 101 for the top portion of the exterior thumb-lever lift bracket 501.

Referring now to FIG. 15, the vertical-to-horizontal motion converter arm 403 is seen in a projection that is perpendicular to it axis of rotation about stand-off pin 106F.

Referring now to FIG. 16, the vertical-to-horizontal motion converter arm 403 is shown in a side view projection taken in a direction depicted by arrow 16 in FIG. 15, and shows the offset required so that the bottom and top portions thereof can operate in different planes.

Referring now to FIG. 17, this view of the back side of the rear thumb-lever lift bracket configured for exterior access 501 shows a hatched region which has been milled, machined, ground, or stamped to reduce sheet metal thickness from about 0.12 inches (approximately 3.05 mm) to about 0.10 inches (approximately 2.54 inches), in order to provide clearance within the mortise housing 101 for rocking bolt-locking plate 401, which has also been thinned as heretofore explained.

Referring now to FIG. 18, this view of the back side of the rear thumb-lever lift bracket configured for interior access 1301 has been milled, machined, ground, or stamped to reduced sheet metal thickness thickness from about 0.12 inches (approximately 3.05 mm) to about 0.10 inches (approximately 2.54 inches), in order to provide clearance within the mortise housing 101 for rocking bolt-locking plate 401, which has also been thinned as heretofore explained. The only difference between rear thumb-lever lift brackets 501 and 1301 is that the edge 1801 has been lowered so that it is not blocked over its range of travel by the locking tab 505 of the solenoid lock 502.

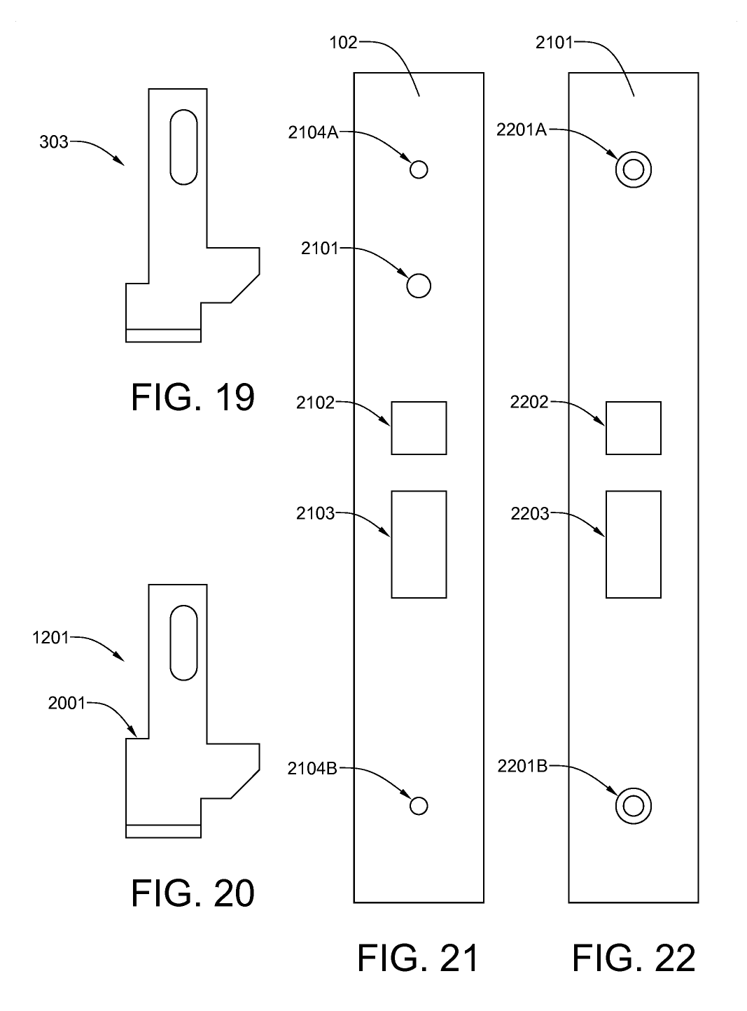

Referring now to FIG. 19, the front thumb-lever lift bracket configured for interior access 303 is fully shown in this view.

Referring now to FIG. 20, the front thumb-lever lift bracket configured for exterior access 1201 is fully shown in this view. The only difference between front thumb-lever lift brackets 303 and 1201 is that the edge 1801 has been raised so that it is normally blocked by the locking tab 505 of the solenoid lock 502. When the solenoid 503 is activated, the locking tab 505 is retracted, allowing thumb-lever bracket 1201 to move unhindered throughout it vertical range of movement.

Referring now to FIG. 21, the main front plate 102, as it would look from the front of the assembled lockset 700, is shown. The round aperture 2101 permits adjustment of the left-hand-threaded screw 202, which moves the pointed locking head 203 and either secures or unsecures the tumbler lock. The security striker bar 304 fits through the square aperture 2102, while the anti-friction, latching striker 104 of the latch bolt 104 fits through the rectangular aperture 2103.

Referring now to FIG. 22, the front trim plate 702 is secured to the front main plate 102 by means of two countersinking head screws (not shown) which pass through countersunk apertures 2201A and 2201B and are secured to the threaded apertures 2104A and 2104B of the main front plate 102. The security striker bar 304 fits through the square aperture 2202, while the anti-friction, latching striker 104 of the latch bolt 104 fits through the rectangular aperture 2203.

Although only several embodiments of the invention have been disclosed herein, it will be obvious to those having ordinary skill in the art that changes and modifications may be made thereto without departing from the spirit and scope of the invention as hereinafter claimed.

What is claimed is:

1. An improved mortise lockset having a latch bolt, a shank of which is installed within an enclosed housing which includes a partially-walled back plate, a front main plate having first and second apertures and a cover plate, a latching striker end of the latch bolt extending through the first aperture, and having a first biasing spring which urges the latch bolt to a fully-extended, latched position, the latch bolt being releasable using thumb-lever actuators from either side of a door in which the lockset is installed, the thumb-lever actuator for outside latch bolt release being normally locked until a solenoid within the housing is temporarily activated from within the secure area or a remote location, wherein the improvement comprises:
a horizontally-slidable security striker bar installed within said housing, and extending through a second aperture in the front main plate;
a second biasing spring which urges the security striker bar to a position that is fully-extended beyond said front main plate;
a rocking bolt-locking plate movable between first and second positions, said first position enabling retraction of the latch bolt, said second position preventing retraction of the latch bolt, said security striker bar contacting and moving said rocking bolt-locking plate to its first position when said security striker bar is fully extended beyond said front main plate, said security striker bar allowing said rocking bolt-locking plate to move to its second position when said security striker bar is retracted into said housing following closure of the door;
vertically-slidable interior and exterior thumb-lever lift brackets accessible through a cutout in the housing;
a vertical-to-horizontal motion converter arm pivotally mounted within the housing, said converter arm coupling said thumb-lever lift brackets to said latch bolt, such that an upward vertical movement of either thumb-lever lift bracket will, first, move said rocking bolt-locking plate to its first position and, second, retract the latch bolt into said housing;
a third biasing spring which urges the motion converter arm toward the front main plate; and
a locking tab which normally blocks upward travel of said exterior thumb-lever lift bracket when in a locked position, and enables upward travel thereof when in a temporary unlocked position, said locking tab being moved to the unlocked position by the solenoid, when activated.

2. The improved mortise lockset of claim 1, wherein a rounded upper end of the vertical-to-horizontal motion converter arm normally rests in a curved depression on an underside of a rear portion of the rocking bolt-locking plate, such that minimal backward pivotal movement of the motion converter arm will move the rocking bolt-locking plate to its first position, thereby enabling retraction of the latch bolt.

3. The improved mortise lockset of claim 1, wherein:
said housing, said latch bolt, said security striker bar, said first and second biasing springs, and said rocking bolt-locking plate are appropriated from a knob-actuated Baldwin® mortise lockset;
said interior and exterior thumb-lever lift brackets, and third biasing spring are appropriated from a thumb-lever-actuated Baldwin® lockset; and
said vertical-to-horizontal motion converter arm, which operates on a protuberance on the front side of the latch bolt shank, is a newly-fabricated component.

4. The improved mortise lockset of claim 3, wherein:
the appropriated rocking bolt-locking plate is reduced in thickness from about 3.05 mm to about 2.54 mm in the region identified in the specification for that component; and
the appropriated thumb-lever lift bracket that is farthest from the front main plate is also reduced in thickness from about 3.05 mm to about 2.54 mm in the region identified in the specification for that component.

5. The improved mortise lockset of claim 3, wherein the vertical-to-horizontal motion converter arm is pivotally mounted within the housing and mechanically couples movement of the thumb-lever lift brackets to both the rocking bolt-locking plate and the latch bolt, such that an upward vertical movement of either thumb-lever lift bracket will move the rocking bolt-locking plate to its first position and, subsequently, retract the latch bolt into said housing.

6. An improved mortise lockset having thumb-lever actuators for both inside and outside latch bolt release, the thumb-lever actuator for outside release being normally locked by a locking tab, said lockset comprising:
a housing, which includes a partially-walled back plate, a front main plate having first and second apertures and a cover plate;
a horizontally-slidable latch bolt installed within said housing, and having a latching striker end which extends through said first aperture;
a first biasing spring, which urges the latch bolt to a fully-extended, latched position;
a horizontally-slidable security striker bar installed within said housing, and extending through said second aperture;
a second biasing spring which urges the security striker bar to a position that is fully-extended beyond said front main plate;
means for preventing release of said latch bolt when said security striker bar is in a retracted position which corresponds to a closed condition of a door in which the lockset is installed, said means for preventing release of said latch bolt being overridden by at least three alternative mechanisms:
actuating the thumb-lever actuator for inside release;
actuating the thumb-lever actuator for outside release after the locking tab is temporarily moved to an unlocking position by a remotely-activatable solenoid; and
rotating a tumbler lock installed in the lockset with a key from the outside.

7. The improved mortise lockset of claim 6, wherein said latch bolt is an anti-friction device that is also secured to the front main plate,

8. The improved mortise lockset of claim 6, wherein said means for preventing comprises:
a rocking bolt-locking plate movable between first and second positions, said first position enabling retraction of the latch bolt, said second position preventing retraction of the latch bolt, said security striker bar contacting and moving said rocking bolt-locking plate to its first position when the former is fully extended beyond said front main plate, said security striker bar allowing said rocking bolt-locking plate to move to its second position when the former is retracted into said housing.

9. The improved mortise lockset of claim 6, wherein said tumbler lock has an unlocking arm that is mechanically coupled to both said latch bolt and said rocking bolt-locking plate, such that when said unlocking arm is rotated, said rocking bolt-locking plate is urged to its first position, after which said latching striker end of the latch bolt is retracted into said housing to its released position.

10. The improved mortise lockset of claim 8, which further comprises:
vertically-slidable interior and exterior thumb-lever lift brackets accessible through a bottom cutout in said housing, said locking tab having a normally-locked position which prevents upward movement of said exterior thumb-lever lift bracket, the locking tab having an unlocked position to which it can be temporarily moved through activation of the solenoid; and
a vertical-to-horizontal motion converter arm pivotally mounted within said housing, said converter arm coupling said thumb-lever lift brackets to said latch bolt, such that an upward vertical movement of either thumb-lever lift bracket will, first, move said rocking bolt-locking plate to its first position and, second, retract the latching striker end of the latch bolt into said housing; and
a third biasing spring, which urges the motion converter arm toward the front main plate.

11. The improved mortise lockset of claim 10, wherein a rounded upper end of the vertical-to-horizontal motion converter arm normally rests in a curved depression on an underside of a rear portion of the rocking bolt-locking plate, such that minimal backward pivotal movement of the motion converter arm will move the rocking bolt-locking plate to its first position, thereby enabling retraction of the latch bolt by additional backward pivotal movement of the motion converter arm, which acts directly on the latch bolt shank.

12. The improved mortise lockset of claim 10, wherein:
said housing, said latch bolt, said security striker bar, said first and second biasing springs, and said rocking bolt-locking plate are appropriated from a knob-actuated Baldwin® mortise lockset;
said interior and exterior thumb-lever lift brackets and said third biasing spring are appropriated from a thumb-lever-actuated Baldwin® lockset; and
said vertical-to-horizontal motion converter arm, which operates on a protuberance on the front side of the latch bolt shank, is a newly-fabricated component.

13. The improved mortise lockset of claim 12, wherein:
the appropriated rocking bolt-locking plate is reduced in thickness from about 3.05 mm to about 2.54 mm in the region identified in the specification for that component; and
the appropriated thumb-lever lift bracket that is farthest from the front main plate is also reduced in thickness from about 3.05 mm to about 2.54 mm in the region identified in the specification for that component.

14. The improved mortise lockset of claim 10, wherein the vertical-to-horizontal motion converter arm is pivotally mounted within the housing and mechanically couples movement of the thumb-lever lift brackets to both the rocking bolt-locking plate and the latch bolt, such that an upward vertical movement of either thumb-lever lift bracket will move the rocking bolt-locking plate to its first position and, subsequently, retract the latching striker end of the latch bolt into said housing.

15. The improved, mortise lockset of claim 9, wherein said tumbler lock has an unlocking arm that is mechanically coupled to both said latch bolt and said rocking bolt-locking plate, such that when said unlocking arm is rotated, said rocking bolt-locking plate is urged to its first position, after which said latch bolt is retracted into said housing to its released position.

16. A method of fabricating an improved mortise lockset having a solenoid release for outside access, the method comprising the steps of:
providing a knob-actuated Baldwin® mortise lockset, said lockset having a housing, which includes a partially-walled back plate, a front main plate having first and second apertures, a security striker bar slidably secured within the housing and passing through said first aperture, a latch bolt slidably secured within the housing and passing through said second aperture, and a cover plate;
replacing the knob actuator components of the previously-identified lockset with the interior and exterior thumb-lever lift brackets from a thumb-lever-actuated Baldwin® lockset;
reducing the thickness of the standard rocking bolt-locking plate from the specified knob-actuated mortise lockset from about 3.05 mm to about 2.54 mm in the region identified in the specification;
reducing the thickness of the thumb-lever lift bracket that is farthest from the front main plate from about 3.05 mm to about 2.54 mm in the region identified in the specification;
providing a new pivotally-mounted, vertical-to-horizontal-motion converter arm which operates on a protuberance on the front side of the latch bolt shank; and
installing a remotely-activated solenoid and a locking tab within the housing, said solenoid being mechanically coupled to the locking tab, said locking tab normally blocking upward movement of the exterior thumb-lever lift bracket when in a locked position, said locking tab being temporarily movable by the solenoid to an unlocked position that does not block upward movement of the exterior thumb-lever lift bracket.

17. The method of fabricating of claim 16, which further includes the step of providing a tumbler lock which installs within either the back plate or the cover plate, said tumbler lock having an unlocking arm that is mechanically coupled to both said latch bolt and said rocking bolt-locking plate, such that when said unlocking arm is rotated, said rocking bolt-locking plate is urged to its first position, after which the latching striker end of said latch bolt is retracted into said housing to its released position.

18. The method of fabricating of claim 16, wherein a rounded upper end of the vertical-to-horizontal motion converter arm normally rests in a curved depression on an underside of a rear portion of the rocking bolt-locking plate, such that minimal backward pivotal movement of the motion converter arm will move the rocking bolt-locking plate to its first position, thereby enabling retraction of the latch bolt by additional backward pivotal movement of the motion converter arm, which acts directly on the latch bolt shank.

19. The method of fabricating of claim 15, wherein a tumbler lock is also appropriated from the knob-actuated mortise lockset, said tumbler lock having a rotating unlocking arm that is mechanically coupled to both said latch bolt and said rocking bolt-locking plate, such that when said unlocking arm is rotated, said rocking bolt-locking plate is urged to its first position, after which said latching striker end of the latch bolt is retracted into said housing to its released position.

20. The method of fabricating of claim 15, which further comprises the steps of:
providing a coil biasing spring appropriated from the thumb-lever-actuated Baldwin® lockset; and
providing a cylindrical projection that is secured to a rear portion of the housing, said cylindrical projection locating one end of the coil biasing spring.
